(19) United States
(12) Patent Application Publication
(10) Pub. No.: US 2006/0267339 A1
(43) Pub. Date: Nov. 30, 2006

(54) Environmental seal adaptable to include EMI shielding

(75) Inventor: Michael Kunkel, Santa Clarita, CA (US)

Correspondence Address: Donald D. Mon;Suite 303, 750 East Green Street, Pasadena, CA, 91101, US

(73) Assignee: Spira Manufacturing Corporation

(21) Appl. No.: 11/140,408

(22) Filed: May 27, 2005

(51) Int. Cl. F16L 27/00; F16L 41/00

(52) U.S. Cl. 285/189

(57) ABSTRACT

An environmental seal with a metal plate with a layer of elastomer bonded to one or both sides, of such thickness and properties as to deform to make a seal but not cold flow under pressure, and optionally includes an EMI gasket inside a circular opening in the washer to make electrical contact with a surface adjacent to both side of the washer.

### FIELD OF THE INVENTION

Providing an environmental seal between a bulkhead-type structure and a structural pass-through for conduitry which can also provide for EMI shielding.

### BACKGROUND OF THE INVENTION

Walls of structural cabinets, housings, bulkheads, and the like often must accommodate passage through them of conduitry of various kinds. Familiar examples are electrical, electronic, and optic cables. Usually there are significant differences between conditions on the opposite sides of these structures such as noxious gases, pressure differentials, gases on one side and liquids on the other, as examples of environmental conditions. Electromagnetic activity on one side which could adversely affect equipment on the other is another example. For these reasons it is not acceptable for the conduitry simply to be passed through an open hole.

Pass-through devices are known for disciplining this essential function. The device of interest to this invention comprises an imperforate tube through which conduits will be passed, and a surrounding mounting flange between the ends of the tube. One end of the tube is passed through the opening in the wall and the flange is brought against the wall. Now each end of the tube projects beyond a respective side of the wall, thereafter to receive conduitry, which itself is suitable isolated. When the device is assembled and suitably connections are made to one or both of the ends, the tube provides a fluid sealed passage from one side of the wall to the other, provided that the flange makes a full seal with the wall at the wall/flange interface.

It is an object of this invention to provide a seal at the wall-flange interface which will prevent environmental leakage past it, and which can optionally also provide a barrier against electromagnetic interference (EMI) past this intersection.

It is another object of this invention to provide an environmental seal which will reliably function for its purpose.

### BRIEF DESCRIPTION OF THE INVENTION

According to this invention, a pass-through to provide a secure passage for a conduit through an opening in a wall includes an imperforate tube with a pair of ends and a passage between these ends. It includes an external integral peripheral flange between said ends. The flange has a face adapted to bear against the wall around an opening through the wall. Fastener means is provided to hold the flange securely against the wall.

According to a feature of this invention, an environmental washer is placed between the wall and the flange, surrounding the opening. This washer comprises a rigid plate, preferably metallic, with a central hole to pass one end of the tube, and on each side of the plate, vulcanized or otherwise strongly attached to said plate, there is a sheet of conformable material which is deformable but not compressible. Shear-like movement of this sheet relative to the surface of the plate to which it is attached, is resisted by its strong attachment to the plate and by the shear properties of the material. Tightening the flange to the wall, with the washer between them, creates on each side of the washer a fluid-tight environmental seal between the flange and the wall. The strap attachment of the sheets to the plate resist extrusion of the washer.

If desired, deformable grommets are placed in bolt holes that pass through the plate and sheets, to embrace bolts-which pass through them and through the wall to mount the flange to the wall.

According to a preferred but optional feature of the invention, an EMI gasket is placed inside the opening in the plate. Its dimensions are such as to make conductive contact with both the wall and the flange when the bolts are tightened down.

According to yet another optional feature of the invention, the EMI gasket has the property of resiliently yielding to compression by the flange and the wall, while still fitting in the hole in the plate without out-of-plane or buckling distortion.

As a consequence, the gasket will make peripheral conductive contact with both the flange and the wall despite the presence of the resilient layers. It is this conductive contact that provides the EMI resistance.

According to yet another optional feature of the invention, the washer is comprised of a conductive metal plate to which the sheet or sheets of deformable but not compressible material are vulcanized or otherwise strongly attached to the plate, the sheet being comprised of conductive elastomeric material.

The above and other features of this invention will be fully understood from the following detailed description and the accompanying drawings, in which:

### BRIEF DESCRIPTION OF THE DRAWINGS

FIG. 1 is a half-section axial view of the presently preferred embodiment of the invention;

FIG. 2 is a cross-section taken at lines 2-2 in FIG. 1;

FIG. 3 is a cross-section of the gasket, only, taken at lines 3-3 in FIG. 2; and

FIG. 4 is a lateral cross-section of an optional embodiment of the invention.

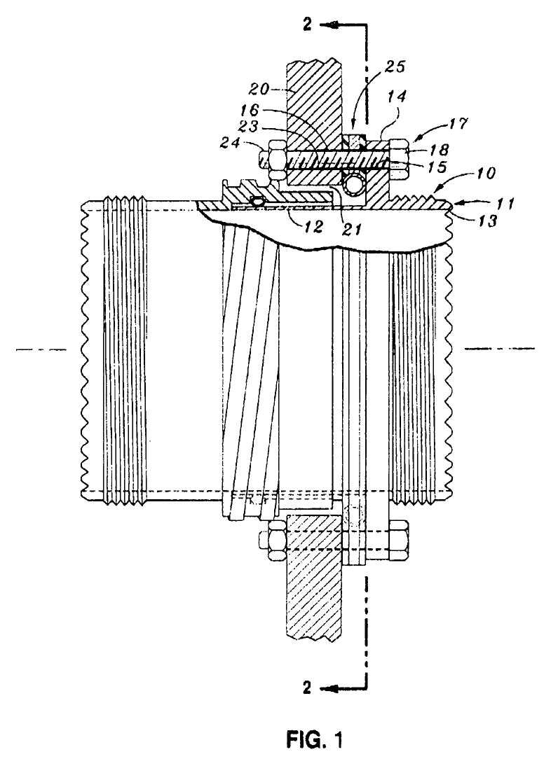

### DETAILED DESCRIPTION OF THE INVENTION

A pass-through 10 useful with which this invention is useful includes a tube 11 having a central passage extending from end 12 to end 13. A peripheral flange 14 extends around the tube, structurally integral with it. The pass-through is metal and fluid impermeable.

The flange includes mounting holes 15 to pass the shanks 16 of bolts 17. A head 18 on each bolt bears against the flange.

A bulkhead 20 or other type of wall has an opening 21 there-through. End 12 of the tube is passed through this opening so the tube extends from one side of the wall to the other. The flange is brought to bear against one face 22 of the wall. Bolt holes 23 through the wall pass respective shanks 16 of the bolts, and nuts 24 are threaded onto them to tighten the assembly. Threaded bolts represent only one type of fastener useful for this purpose. Other types such as rivets could be used instead.

Without a washer, this assembly would leak between the flange, tube and wall. To avert this situation, an environmental washer 25 is placed between the flange and face 22 of the wall.

As best shown in FIG. 3, the washer includes an electrically conductive metal plate 26, and on each side of the plate, a layer 27, 28 of a deformable but incompressible material. Elastomers suitably resistant to anticipated conditions of use are examples. Common rubbers such as are used for vehicle tire tubes are useful examples.

When electrical conducitivity is a desirable property, layers 27 and 28 may be made conductive by incorporating conductive materials into them. In many situations, this will provide adequate EMI protection.

These layers are tightly bonded to the metal plate, such as by vulcanization. This bond is for the purpose of preventing creep of the material when compressed between the wall and the flange. Preferably the thickness of layers 27 and 28 is kept to a minimum, further to resist shear-like or sideward deformation (being “extruded out”). Minimizing the thickness of layers 27, 28 while still providing sufficient height to conform to irregularities in the confronting surface, minimizes the amount of layer material, and thereby minimizes shear-like movement of the layers when under a compressive load.

Suitable dimensions for the washer are:

Thickness of metal plate 26: 0.010 inch

Thickness of layers 27 and 28: 0.015 inch

Only layer 27 need be provided, but this would be a rare situation.

If desired, grommets (not shown) can be provided around the holes in the washer. These can provide an additional seal around the bolt shanks and with the holes through the wall.

A cable 38 or other elongated articles pass through.

The foregoing describes a useful environmental seal around the pass-through, which will isolate the tube passage from its surroundings, The tube itself will be connected to other means to isolate the passage, but this arrangement isolates the pass-through itself relative to the environment on opposite sides of the wall.

For optimal resistance to EMI, a gasket 35 may be added to this washer. Its intended use is to make conductive contact between the wall and the flange. Accordingly its diameter is larger than the diameter of the opening through the wall so that it can contact the wall. This is the preferred embodiment of this invention.

This gasket can be the type shown in Kunkel U.S. Pat. No. 3,502,784, issued Mar. 24, 1970, which is incorporated herein by reference in its entirety for its showing of such a gasket and its construction. Essentially it is a wound flat strap of metal, bent as a helical body into a circular cross-section shape that is fitted into wall 36 of the wall in the washer. Other commercially available conductive gasket material may also be used.

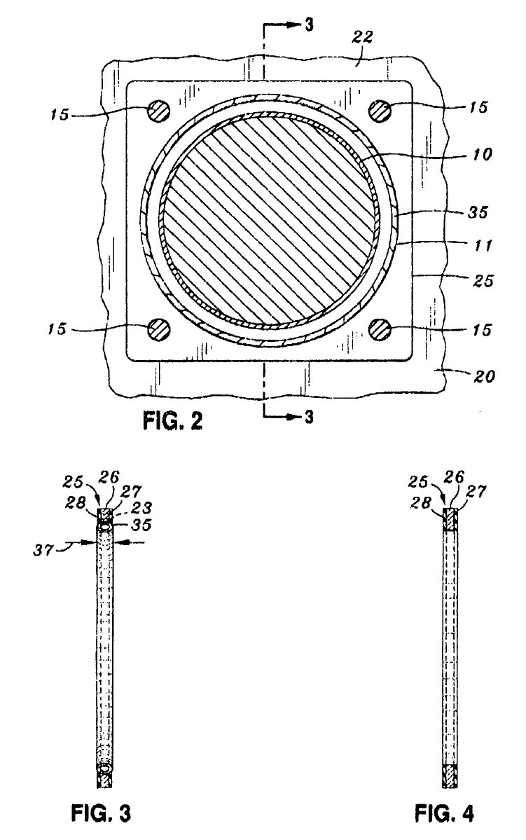

As best shown in FIGS. 2 and 3, this gasket has an initial outer diameter 37 that is equal to the total thickness of the washer, or projects slightly above the washer material on both sides. It will make conductive contact with the flange and the wall when the structure is tightened down. If it is close to the outer level of the layers, it must be close enough that when the joinder is tightened down, the gasket will make contact with the all and the flange. If it projects beyond layers 27 and 28, as is preferable, it can be deflected to permit the environmental seal to be made.

This gasket is well known for its EMI resistant properties. It is not necessary, but it is preferable, for it to extend completely around the inside wall of the washer. It is an interesting property of this gasket that it can deform to an ovalled cross-section under lateral compression without out-of-plane distortion. For this reason, a complete circular gasket can be inserted, which when laterally compressed will continue to make full contact, but without out-of-plane distortion, or internal buckling.

With this gasket installed, the washer provides both environmental and EMI protection.

This invention is not to be limited by the embodiments shown in the drawings and described in the description, which are given by way of example and not of limitation, but only in accordance with the scope of the appended claims.

1. A washer for use in providing an environmental seal between a pass-through and a wall having an opening for the pass-through and a face, said pass-through comprising a metal tube having a first and a second end, with a passage extending between said ends, and a peripheral flange integral with said tube projecting laterally from said tube, said flange having a face facing toward said wall when the said first end is inserted into said opening, said washer intended for placement between said flange face and wall, comprising:
a conductive metal plate; and
intimately bonded to said metal plate, a layer of deformable but incompressible material placed around said tube with said layer abutting said wall, whereby to form an environmental seal between them.

2. A washer according to claim 1 in which one of said layers is applied to each side sides of said metal plate.

3. A washer according to claim 1 in which the material of said layer is a rubber-like elastomer vulcanized to said metal plate.

4. A washer according to claim 3 in which said plate and said layers are electrically conductive.

5. A washer according to claim 3 in which a plurality of bolt holes is formed through said washer to enable the passage of a bolt shank.

6. A washer according to claim 5 in which a flexible grommet is fitted around each of said bolt holes.

7. A washer according to claim 1 further including a conductive gasket fitted inside said metal plate, so proportioned and arranged as to contact the wall on one side and the flange on the other side when the flange is brought against the washer, said gasket being springily deformable to maintain its contact with the flange and the wall while not interfering with the contact of the layers with the flange and the wall.

8. A washer according to claim 7 in which said gasket is a helically-wound flat conductive metal strip bent to fit in the washer.

9. A washer according to claim 8 in which said gasket has a diameter which enables unimpeded contact with said wall and said flange when the flange is tightened toward said wall.

10. In combination:
A pass-through and a washer both as defined in claim 1, said washer being placed between said flange and said wall, with said flange brought strongly toward said face to form an environmental seal between them.

11. A combination according to claim 10 in which one of said layers is applied to both sides of said metal plate.

12. A combination according to claim 10 in which the material of said layer is a rubber-like elastomer vulcanized to said metal plate.

13. A combination according to claim 12 in which a plurality of bolt holes is formed through said washer to enable the passage of a bolt shank.

14. A combination according to claim 13 in which a flexible grommet is fitted around each of, said bolt holes.

15. A combination according to claim 10 further including a conductive gasket fitted inside said metal plate, so proportioned and arranged as to contact the wall on one side and the flange on the other side when the flange is brought against the washer.

16. A combination according to claim 15 in which said gasket is a helically-wound flat conductive metal strip bent to fit in the washer.

17. A combination according to claim 16 in which said gasket has a diameter which enables unimpeded contact with said wall and said flange when the flange is tightened toward said wall.

18. An environmental washer comprising a planar metal plate, and on each side of said plate a planar layer, strongly bonded to said plate, of a resiliently deformable material, the washer having a central hole there through.

19. A washer according to claim 18 in which said plate and said layer are electrically conductive.
